(19) United States
(12) Patent Application Publication
(10) Pub. No.: US 2026/0359175 A1
(43) Pub. Date: Nov. 12, 2026

(54) METHOD AND APPARATUS FOR AUTOMATIC RECOVERY OF STATEFUL WORKLOADS IN KUBERNETES-BASED MULTI-CLUSTERS

(71) Applicant: FOUNDATION OF SOONGSIL UNIVERSITY-INDUSTRY COOPERATION, Seoul (KR)

(72) Inventors: Young Han KIM, Seoul (KR); Mu Seong KWON, Seoul (KR)

(73) Assignee: FOUNDATION OF SOONGSIL UNIVERSITY-INDUSTRY COOPERATION, Seoul (KR)

(21) Appl. No.: 19/418,092

(22) Filed: Dec. 12, 2025

(30) Foreign Application Priority Data
May 12, 2025 (KR) 10-2025-0061285

(51) Int. Cl. G06F 11/20

(52) U.S. Cl. CPC G06F 11/203; G06F 2201/805

(57) ABSTRACT

A stateful workload automatic recovery method and apparatus in a Kubernetes-based multi-clusters. The stateful workload automatic recovery apparatus in a Kubernetes-based multi-clusters includes: a storage synchronization controller configured to collect specification information of a PersistentVolume (PV) associated with a StatefulSet resource deployed in a first member cluster, and to store the collected specification information in a PV-related resource delivery unit within a namespace of a first member cluster in the form of PV metadata; and a storage migration controller configured to, when a failure occurs in the StatefulSet resource deployed in the first member cluster, identify a rescheduled second member cluster, and to generate, by referring to the PV-related resource delivery unit, a PV-related resource delivery unit in a namespace of the second member cluster such that PV resources associated with the StatefulSet resource are deployed in the second member cluster.

### CROSS-REFERENCE TO RELATED APPLICATIONS

This application claims the benefit of Korean Patent Application 10-2025-0061285, filed on May. 12, 2025, in the Korean Intellectual Property Office. All disclosures of the document named above is incorporated herein by reference.

### TECHNICAL FIELD

The present invention relates to a method and an apparatus for automatic recovery of stateful workloads in Kubernetes-based multi-clusters.

### BACKGROUND ART

With the spread of microservice architectures in cloud environments, Kubernetes has become widely used for deploying, managing, and scaling various services and applications at the container level. In particular, systems that require high availability and failure recovery are increasingly adopting multi-cluster environment, in which multiple clusters are configured to operate services beyond a single-cluster environment.

In such multi-cluster environment, each cluster is physically distributed and manages resources independently. Therefore, even if a failure occurs in one cluster, it is necessary to provide an architecture in which the workload can be recovered or replaced in another cluster, thereby ensuring service continuity of the entire system.

However, while existing Kubernetes environments make recovery of stateless workloads relatively easy, recovery of stateful workloads is complex and limited. This is because stateful workloads are tightly coupled with storage resources such as PersistentVolumes (PV), and there are technical constraints in coordinating and replicating storage resources across clusters.

Some open-source and commercial solutions provide functions for migrating stateful workloads to other clusters or for snapshot-based or backup/restore-based recovery. However, such approaches often require manual intervention or involve long recovery times, creating limitations for rapid, fully automated recovery. In addition, it is difficult to ensure consistency at the time of recovery.

Accordingly, there is a growing need for a technology that, in a multi-cluster environment, can detect failures affecting stateful workloads and automatically recover them in another cluster, as well as a technology that can determine an appropriate recovery cluster and automate the recovery process based on workload state, storage state, replication state, and other relevant factors.

### Disclosure

### Technical Problem

To address the problems of the prior art described above, the present invention proposes a method and an apparatus for automatic recovery of stateful workloads in Kubernetes-based multi-clusters, which can efficiently perform automatic recovery of a stateful workload in which a failure has occurred.

### Technical Solution

According to one embodiment of the present invention, a stateful workload automatic recovery apparatus in Kubernetes-based multi-clusters comprises a storage synchronization controller configured to collect specification information of a PersistentVolume (PV) associated with a StatefulSet resource deployed in a first member cluster, and to store the collected specification information in a PV-related resource delivery unit within a namespace of a first member cluster in the form of PV metadata; and a storage migration controller configured to, when a failure occurs in the StatefulSet resource deployed in the first member cluster, identify a rescheduled second member cluster, and to generate, by referring to the PV-related resource delivery unit, a PV-related resource delivery unit in a namespace of the second member cluster such that PV resources associated with the StatefulSet resource are deployed in the second member cluster.

The stateful workload automatic recovery apparatus may further comprise an execution-related controller configured to detect a resource delivery unit for the StatefulSet resource and the PV-related resource delivery unit generated in the namespace of the second member cluster, and to deploy the PV resources associated with the StatefulSet resource in the second member cluster.

The stateful workload automatic recovery apparatus may further comprise a state monitoring controller configured to periodically monitor StatefulSet resources deployed in each member cluster and update resource status in a resource-binding object; and a failover-related controller configured to periodically monitor the resource-binding object, determine whether a preset failure-determination condition is satisfied, remove a cluster, in which a failure has occurred, from the resource-binding object, and set a suspension for a StatefulSet resource, in which a failure has occurred.

The storage migration controller may remove a first member cluster, in which a failure has occurred, from the resource-binding object and trigger a scheduler to perform rescheduling when the failure-determination condition set in the resource-binding object is satisfied.

The storage migration controller may detect an updated resource-binding object, identify a rescheduled second member cluster, and generate a PV-related resource delivery unit in a namespace of the second member cluster.

The stateful workload automatic recovery apparatus may further comprise a binding-related controller configured to detect an updated resource-binding object and generate a resource delivery unit in the namespace for the second member cluster.

The storage migration controller may release the suspension setting when the PV status within a PV-related resource delivery unit in the namespace of the second member cluster is updated by the state monitoring controller, and the PV status transitions to an available state.

The storage migration controller may remove the PV resource delivery unit in the namespace of the second member cluster after deployment of PV resources associated with the StatefulSet resource has been completed in the second member cluster.

The storage synchronization controller may periodically query, from a Kube-API server of the first member cluster, the StatefulSet resource and associated PersistentVolumeClaim (PVC) and PV resources, and collect and store metadata relating to capacity, storage class, and access mode of the PV.

According to another embodiment of the present invention, a method for automatically recovering stateful workloads in Kubernetes-based multi-clusters performed in a management cluster comprises collecting specification information of a PersistentVolume (PV) associated with a StatefulSet resource deployed in a first member cluster; storing the collected specification information in a PV-related resource delivery unit within a namespace of a first member cluster in the form of PV metadata; identifying, when a failure occurs in the StatefulSet resource deployed in the first member cluster, a rescheduled second member cluster, and generating a PV-related resource delivery unit in a namespace of the second member cluster by referring to the PV resource delivery unit; and deploying PV resources associated with the StatefulSet resource in the second member cluster.

According to yet another embodiment of the present invention, a computer program executed by a processor to automatically recover stateful workloads in Kubernetes-based multi-clusters, wherein the computer program is configured to perform operations comprising collecting specification information of a PersistentVolume (PV) associated with a StatefulSet resource deployed in a first member cluster; storing the collected specification information in a PV-related resource delivery unit within a namespace of a first member cluster in the form of PV metadata; identifying, when a failure occurs in the StatefulSet resource deployed in the first member cluster, a rescheduled second member cluster, and generating a PV-related resource delivery unit in a namespace of the second member cluster by referring to the PV resource delivery unit; and deploying PV resources associated with the StatefulSet resource in the second member cluster.

### Advantageous Effects

According to the present invention, by pre-collecting and storing metadata of the PV that existed in the original cluster and automatically restoring it to a new cluster when a failure occurs, service high availability can be ensured without requiring manual operations by an administrator.

In addition, according to the present invention, by collecting PVs generated in each cluster and centrally storing them as metadata, integrated management of PVs becomes possible. Furthermore, by cleaning up the additional resources generated in relation to PV generation after the recovery process, leakage of system-wide resources can be prevented.

Moreover, since the present invention can detect the result of the rescheduling mechanism of the multi-cluster management system, identify the cluster to which the workload will be re-deployed, and pre-deploy the PV, it enables a flexible response even in dynamic cluster environments.

### DESCRIPTION OF DRAWINGS

These and/or other aspects will become apparent and more readily appreciated from the following description of the embodiments, taken in conjunction with the accompanying drawings in which:

FIG. 1 is a diagram illustrating a conventional workload deployment process.

FIG. 2 is a diagram illustrating a stateful workload failure-recovery process when a failure occurs according to the prior art.

FIG. 3 is a diagram illustrating a pre-failure processing procedure according to an embodiment of the present invention.

FIG. 4 is a diagram illustrating a processing procedure when a stateful workload failure occurs according to an embodiment of the present invention.

### DETAILED DESCRIPTION OF EMBODIMENTS

The present invention may be modified in various ways and may have several embodiments. Certain embodiments are illustrated in the drawings and will be described in detail in the specification. However, this is not intended to limit the present invention to specific embodiments, and it should be understood to include all modifications, equivalents, and alternatives that fall within the spirit and scope of the invention.

The terminology used in this specification is for the purpose of describing particular embodiments only and is not intended to limit the invention. The singular forms used herein are intended to include the plural forms as well, unless the context clearly indicates otherwise. In this specification, terms such as “comprise” or “have” are intended to specify the presence of stated features, numbers, steps, operations, components, parts, or combinations thereof, but do not preclude the possibility of the presence or addition of one or more other features, numbers, steps, operations, components, parts, or combinations thereof.

In addition, the components of the embodiments described with reference to the accompanying drawings are not limited to the specific embodiments, and they may be implemented to be included in other embodiments within the scope of the technical spirit of the present invention. Furthermore, it is to be understood that, even if not separately described, multiple embodiments may naturally be integrated into a single embodiment.

Also, in the description with reference to the accompanying drawings, the same or corresponding reference numerals are used to denote the same or related components regardless of the figure numbers, and redundant descriptions thereof will be omitted. In the description of the present invention, detailed explanations of known technologies related to the invention will be omitted when it is deemed that such details would unnecessarily obscure the gist of the invention.

According to the present embodiment, the invention relates to a device for stably operating stateful workloads (hereinafter referred to as a StatefulSet, a StatefulSet resource, or a StatefulSet pod) in a multi-cluster environment and for preserving data and supporting automatic recovery when a failure occurs. More specifically, the present embodiment proposes a method for integrally managing multiple Kubernetes clusters and automatically deploying and recovering resources, including stateful workloads.

A multi-cluster management system is a platform that enables centralized management and operation of multiple Kubernetes clusters through a single interface. Through such a system, clusters distributed across various infrastructures, such as public clouds, private data centers, and edge environments, can be effectively controlled. This system simplifies the deployment, scaling, and monitoring of applications and enhances high availability and failure-recovery capabilities.

The present embodiment concerns workload automatic recovery, and the conventional recovery process will first be described below.

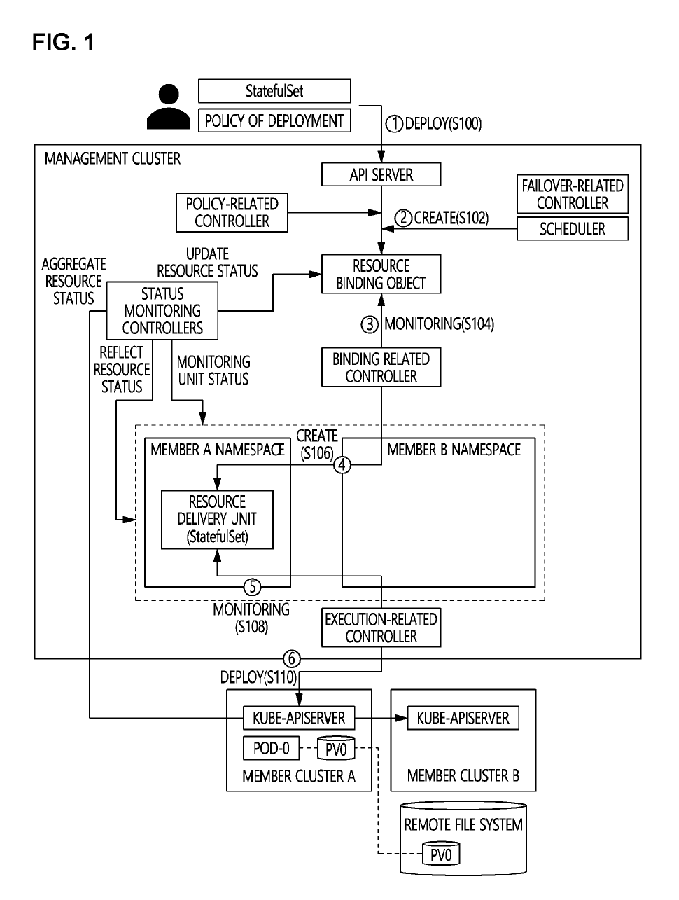

FIG. 1 is a diagram illustrating a conventional workload deployment process.

Referring to FIG. 1, resources are delivered to member clusters according to a deployment policy defined by the user through the following procedure.

First, the user registers the deployment policy and resources through the API server (APIServer) (step 100). The policy-related controller and scheduler then interpret the policy and generate a resource-binding object that includes binding information with the resources (step 102).

The resource-binding object serves as a mediator that ensures the resources are deployed to appropriate member clusters in accordance with the user's policy.

Next, the binding-related controller monitors the resource-binding object (step 104) and, based on the information contained therein, generates a resource delivery unit (step 106).

The resource delivery unit is a transmission structure used by the central control system (management cluster) to deploy resources to specific member clusters in a multi-cluster environment. It includes one or more resource definitions (e.g., PersistentVolume (PV), ConfigMap, etc.) and contains the information necessary for generating such resources in the execution member cluster.

Finally, the execution-related controller continuously monitors the namespaces corresponding to each member cluster and detects a resource delivery unit (step 108).

Upon detecting a new resource delivery unit, the execution-related controller deploys the resources into the actual member cluster based on the corresponding information (step 110).

Some applications include not only simple stateless Pods but also stateful workloads that should preserve data.

For example, applications such as databases require each Pod to have a unique network identifier and a PV, and therefore, simple redeployment across clusters makes it difficult to maintain data consistency.

To address this issue, Kubernetes provides the workload API object for managing applications that have the StatefulSet state, and it has the following characteristics.
1. Unique network identifiers: Each Pod has a unique hostname and retains the same identifier even when restarted or rescheduled.
2. Persistent storage: Each Pod is connected to a PV through a dedicated PersistentVolumeClaim (PVC), and the data is preserved even if the Pod is deleted.
3. Ordered deployment and termination: Pod generation and termination are ordered to maintain application stability and data integrity.

To guarantee these characteristics of a StatefulSet, consistent mapping between Pods and PVs is required. Each StatefulSet Pod is connected to a specific PV through a dedicated PVC, ensuring access to the same storage even after restart or rescheduling. Additionally, the claimRef specification of a PV represents the relationship between the PV and the PVC, maintains a one-to-one binding, and ensures that the StatefulSet PVC uses the designated PV.

However, the following issues may arise when operating a StatefulSet in a multi-cluster environment:
(1) The entire cluster may become non-operational due to natural disasters, network partitioning, or hardware failures.
(2) A specific cluster may lack resources, such as CPU, memory, or storage.

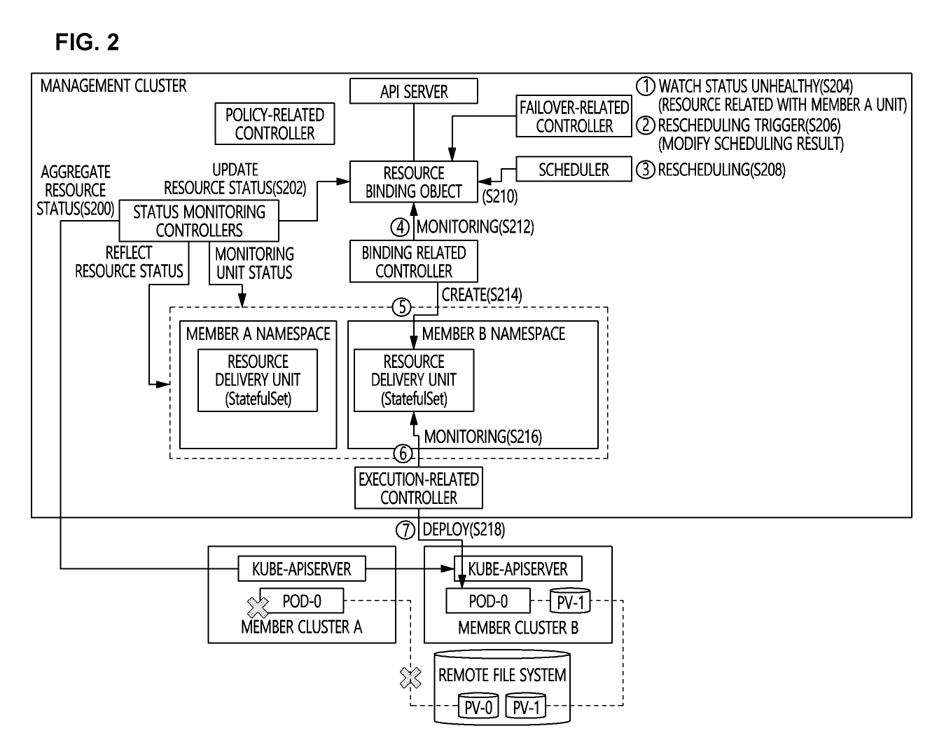

FIG. 2 is a diagram illustrating a stateful workload failure-recovery process when a failure occurs according to the prior art.

Referring to FIG. 2, the plurality of status monitoring controllers in the management cluster periodically collect resource status deployed to a plurality of member clusters (step 200) and update the resource status information in the resource-binding object (step 202).

Then, the failover-related controller periodically monitors the resource-binding object (step 204) and initiates operation when predefined failure-determination conditions are satisfied.

The failover-related controller removes the member cluster, in which failure has been determined, from the cluster list within the resource-binding object and triggers the scheduler (step 206).

The scheduler recognizes the failure and performs rescheduling (step 208), and updates the rescheduling result to the resource-binding object (step 210).

Next, the binding-related controller detects the modified resource-binding object (step 212) and generates a new resource delivery unit in the namespace for the target cluster within the management cluster (step 214).

The execution-related controller monitors a namespace of each member cluster within the management cluster and detects the generated resource delivery unit (step 216).

Based on information included in the detected resource delivery unit, the execution-related controller deploys the resources to the corresponding member cluster, thereby completing the automatic recovery of the stateful workload (step 218).

To guarantee these characteristics of a StatefulSet, consistent mapping between Pods and PVs is required. Each StatefulSet Pod is connected to a specific PV through a dedicated PVC, ensuring that the Pod can access the same storage even when restarted or rescheduled. In addition, the claimRef specification of a PV is a field that represents the relationship between the PV and the PVC, maintains a one-to-one binding relationship, and ensures that the PVC of the StatefulSet uses the designated PV.

However, existing multi-cluster management controllers provide the capability to relocate StatefulSet Pods and PVCs to another cluster, but they lack sufficient functionality for transferring and restoring the PV itself. Consequently, even if the target Pod is moved to a new cluster when a failure occurs, the existing PV cannot be accessed from that cluster, and a newly generated PV is not associated with the existing data, resulting in an inability to guarantee the data consistency of the StatefulSet.

The present embodiment aims to solve these problems by designing a control device and internal component modules capable of performing consistent relocation of storage resources including the data of stateful workloads between multiple clusters.

In this embodiment, the specification information of the storage resource (PV resource) existing in the original cluster is stored in the central control cluster (management cluster) in the form of metadata. Based on this information, the storage resource is automatically generated and deployed in the rescheduled member cluster, and after verifying the state, unnecessary resources are cleaned up. Through this sequence of operations, service recovery can be achieved while maintaining data consistency without the need for an administrator’s intervention.

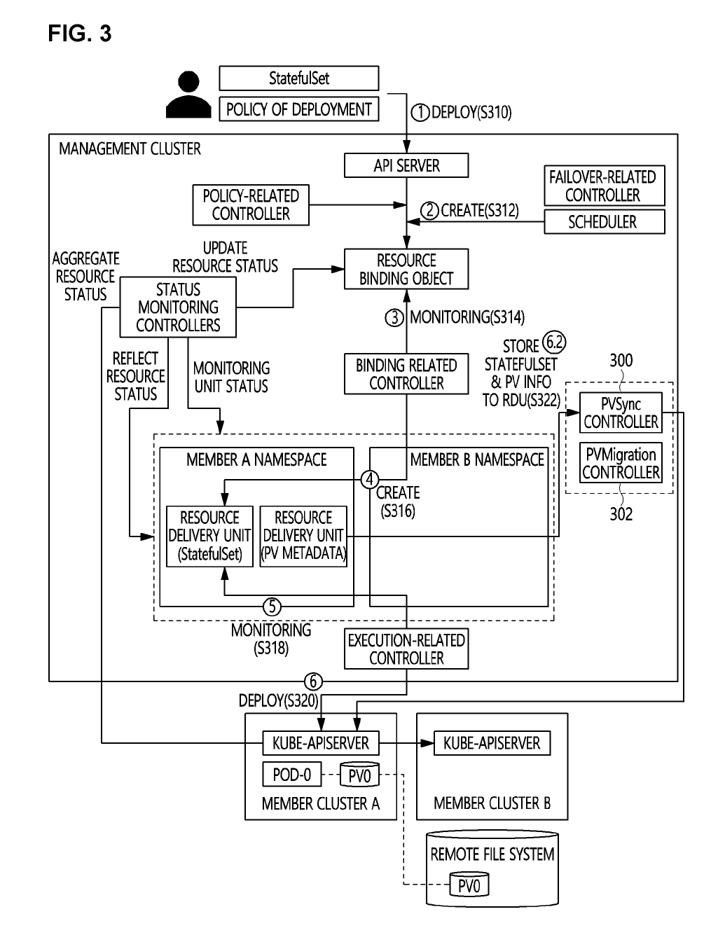

FIG. 3 is a diagram illustrating a pre-failure processing procedure according to an embodiment of the present invention.

As illustrated in FIG. 3, the stateful workload automatic recovery apparatus according to the present embodiment may further comprise, in addition to the components shown in FIGS. 1 and 2, a storage synchronization controller (PVSyncController, 300) and a storage migration controller (PVMigrationController, 302).

The storage synchronization controller 300 collects specification information of PVs associated with StatefulSet resources deployed in each member cluster, processes the collected PV specification information into a ConfigMap format, and stores it in the PV resource delivery unit as metadata within the namespace of the member cluster in which the StatefulSet resource is deployed in the management cluster.

The storage migration controller 302 detects the resource-binding object related to the deployment of the StatefulSet resource and determines that recovery is required when the resource status in the object is unhealthy and a suspension setting is applied. Based on the previously stored PV metadata, a PV-related resource delivery unit is automatically generated in the rescheduled cluster.

Next, the controller monitors whether deployment of the corresponding PV resource is successful, and when normal generation is confirmed, it releases the suspension setting and then automatically cleans up metadata and unnecessary resources that existed in the previous cluster.

Referring to FIG. 3, when the user registers the deployment policy and resources in the management cluster (step 310), the policy-related controller and scheduler generate a resource-binding object through the APIServer (step 312).

The binding-related controller monitors the generated resource-binding object (step 314) and, based on this object, generates a StatefulSet-related resource delivery unit in the namespace of the target cluster inside the management cluster (step 316).

The execution-related controller monitors the namespaces of each member cluster to detect the resource delivery unit (step 318), and deploys the resources to the corresponding member cluster using the detected information (step 320).

During this process, the storage synchronization controller 300 collects the PV specification information corresponding to the StatefulSet resource deployed in the member cluster and stores the collected PV specification information, in the form of metadata as a ConfigMap resource, in the PV-related resource delivery unit (step 322).

This ConfigMap resource is used as reference data for maintaining data consistency during a failure and is applied during the process of generating storage resources with the same specification as the PV used in the failure cluster, thereby enabling data consistency to be preserved.

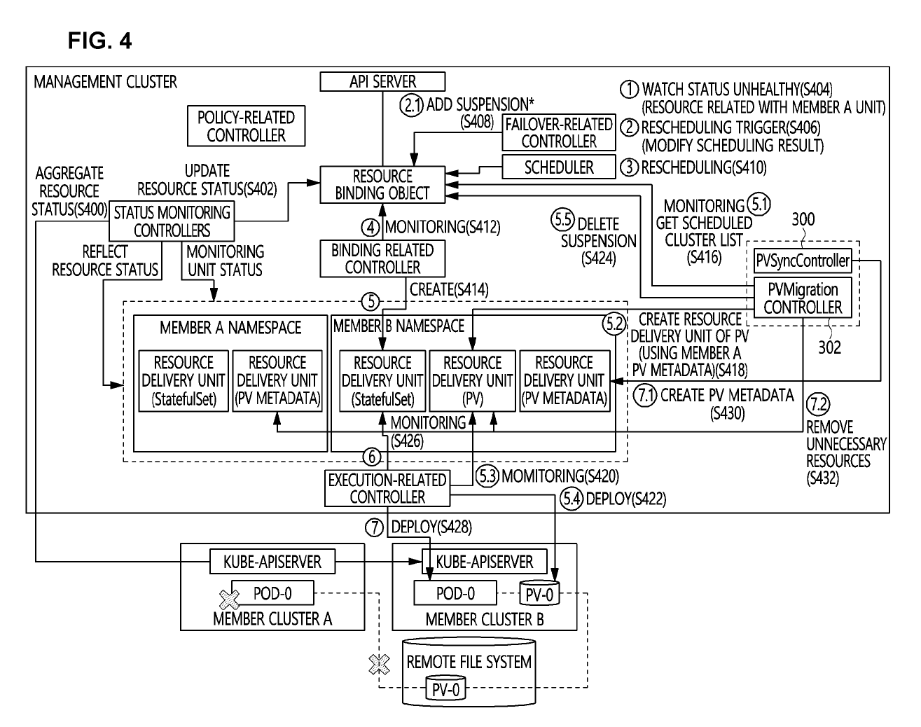

FIG. 4 is a diagram illustrating the processing procedure when a stateful workload failure occurs according to the present embodiment.

According to the present embodiment, the management cluster performs functions for controlling the deployment process of StatefulSet resources and applies a suspension setting to temporarily halt additional deployments of the resource until the recovery process begins in the event of a failure.

This setting is reflected in the resource-binding object related to the StatefulSet deployment as a suspension attribute, blocking the normal deployment flow and temporarily pausing the failure-recovery process.

Thereafter, the storage migration controller 302 may perform operations by querying the StatefulSet-related resource-mapping object, determining whether a deployment suspension setting has been applied to the object, and verifying whether the resource status in the status field of the object is unhealthy, thereby determining whether a failure has occurred.

Referring to FIG. 4, the status monitoring controllers periodically collect status information for resources deployed in the member clusters (step 400) and update the resource status within the resource-binding object (step 402).

The failover-related controller periodically monitors the resource-binding object and operates according to predefined failure-determination conditions.

The failover-related controller determines whether a failure has been confirmed (step 404), and when a failure is confirmed, it removes the cluster, in which a problem has occurred, from the list within the object and triggers the scheduler (step 406). At the same time, the failover-related controller sets a suspension in the resource-binding object of the failed resource so that the resource is not deployed to a member cluster. (step 408).

The scheduler also recognizes the problem and performs rescheduling, updating the rescheduling results in the resource-binding object (step 410).

Next, the binding-related controller detects the updated resource-binding object (step 412).

Based on the information contained in the object, the binding-related controller generates a resource delivery unit in the namespace (Member B Namespace) for the target cluster, to which the resources will be deployed, inside the management cluster (step 414).

The storage migration controller 302 monitors the resource-binding object and identifies the rescheduled member cluster (step 416).

The storage migration controller 302 refers to the PV metadata resource delivery unit generated by the storage synchronization controller 300 and generates a PV-related resource delivery unit that contains the PV specification information for the rescheduled member cluster (step 418).

The execution-related controller monitors the namespaces of each member cluster in the management cluster and detects the PV-related resource delivery unit (step 420).

Once the PV-related resource delivery unit is detected, the execution-related controller generates the PV in the corresponding member cluster based on the information in the object (step 422).

Step 422 represents the process of deploying PV resources associated with the StatefulSet resource in a member cluster different from the one before the failure.

As the PV status is updated by the status monitoring controller within the PV-related resource delivery unit, by referring to this, the storage migration controller 302 releases the suspension in the resource-binding object when the status becomes available (step 424).

The execution-related controller monitors the namespaces of each member cluster in the management cluster to detect resource delivery units (step 426), and when a resource delivery unit is detected, deploys resources to the corresponding cluster based on the information in the object (step 428).

Because resources have been migrated during failure recovery, the execution-related controller generates a PV-related resource delivery unit for the new cluster (step 430).

The storage migration controller 302 removes the resource delivery units that were additionally generated during the failure-recovery process (step 432).

Step 432 corresponds to the removal of the PV resource delivery unit within the namespace of member cluster A shown in FIG. 4.

This is to ensure that the metadata remains up-to-date before and after the StatefulSet failure recovery. Additionally, the storage migration controller 302 may remove the resource delivery unit used for generating the PV corresponding to the PV deployed in the new member cluster, in order to release dependencies on the PV.

The above-described method for automatic recovery of stateful workloads in Kubernetes-based multi-clusters may also be implemented in the form of a computer-readable recording medium containing program instructions executable by a computer, such as an application or program module. A computer-readable medium may be any available medium accessible by a computer processor and includes both volatile and non-volatile media as well as removable and non-removable media. Additionally, a computer-readable medium may include computer storage media. Computer storage media include both volatile and non-volatile, removable and non-removable media, implemented in any method or technology for storing information such as computer-readable instructions, data structures, program modules, or other data.

The embodiments described herein are disclosed for illustrative purposes, and various modifications, changes, and additions can be made by those skilled in the art without departing from the spirit and scope of the invention. Such modifications, changes, and additions should be considered as falling within the scope of the following claims.

1. A stateful workload automatic recovery apparatus in Kubernetes-based multi-clusters comprising:
a storage synchronization controller configured to collect specification information of a PersistentVolume (PV) associated with a StatefulSet resource deployed in a first member cluster, and to store the collected specification information in a PV-related resource delivery unit within a namespace of the first member cluster in the form of PV metadata; and
a storage migration controller configured to, when a failure occurs in the StatefulSet resource deployed in the first member cluster, identify a rescheduled second member cluster, and to generate, by referring to the PV-related resource delivery unit, a PV-related resource delivery unit in a namespace of the second member cluster such that PV resources associated with the StatefulSet resource are deployed in the second member cluster.

2. The stateful workload automatic recovery apparatus of claim 1 further comprises,
an execution-related controller configured to detect a resource delivery unit for the StatefulSet resource and the PV-related resource delivery unit generated in the namespace of the second member cluster, and to deploy the PV resources associated with the StatefulSet resource in the second member cluster.

3. The stateful workload automatic recovery apparatus of claim 1 further comprises,
a state monitoring controller configured to periodically monitor StatefulSet resources deployed in each member cluster and update resource status in a resource-binding object; and
a failover-related controller configured to periodically monitor the resource-binding object, determine whether a preset failure-determination condition is satisfied, remove a cluster, in which a failure has occurred, from the resource-binding object, and set a suspension for a StatefulSet resource, in which a failure has occurred.

4. The stateful workload automatic recovery apparatus of claim 3, wherein the storage migration controller is further configured to remove a first member cluster, in which a failure has occurred, from the resource-binding object and trigger a scheduler to perform rescheduling when the failure-determination condition set in the resource-binding object is satisfied.

5. The stateful workload automatic recovery apparatus of claim 4, wherein the storage migration controller is further configured to detect an updated resource-binding object, identify a rescheduled second member cluster, and generate a PV-related resource delivery unit in a namespace of the second member cluster.

6. The stateful workload automatic recovery apparatus of claim 5 further comprises,
a binding-related controller configured to detect an updated resource-binding object and generate a resource delivery unit in the namespace for the second member cluster.

7. The stateful workload automatic recovery apparatus of claim 6, wherein the storage migration controller is further configured to release the suspension setting when PV status within a PV-related resource delivery unit in the namespace of the second member cluster is updated by the state monitoring controller and the PV status transitions to an available state.

8. The stateful workload automatic recovery apparatus of claim 7, wherein the storage migration controller is further configured to remove the PV resource delivery unit in the namespace of the second member cluster after deployment of PV resources associated with the StatefulSet resource has been completed in the second member cluster.

9. The stateful workload automatic recovery apparatus of claim 1, wherein the storage synchronization controller is further configured to periodically query, from a Kube-API server of the first member cluster, the StatefulSet resource and associated PersistentVolumeClaim (PVC) and PV resources, and to collect and store metadata relating to capacity, storage class, and access mode of the PV.

10. A method for automatically recovering stateful workloads in Kubernetes-based multi-clusters performed in a management cluster comprising:
collecting specification information of a PersistentVolume (PV) associated with a StatefulSet resource deployed in a first member cluster;
storing the collected specification information in a PV-related resource delivery unit within a namespace of a first member cluster in the form of PV metadata;
identifying, when a failure occurs in the StatefulSet resource deployed in the first member cluster, a rescheduled second member cluster, and generating a PV-related resource delivery unit in a namespace of the second member cluster by referring to the PV resource delivery unit; and
deploying PV resources associated with the StatefulSet resource in the second member cluster.

11. The method of claim 10, wherein the deploying further comprises:
detecting a resource delivery unit for the StatefulSet resource and the PV-related resource delivery unit generated in the namespace of the second member cluster before deploying the PV resources associated with the StatefulSet resource in the second member cluster.

12. The method of claim 10 further comprises,
periodically monitoring a StatefulSet resource deployed in each member cluster and updating resource status in a resource-binding object; and
periodically monitoring the resource-binding object to determine whether a preset failure-determination condition is satisfied, removing a cluster, in which a failure has occurred, from the resource-binding object, and setting a suspension for a StatefulSet resource, in which a failure has occurred.

13. The method of claim 12 further comprises,
after generating the PV-related resource delivery unit,
removing a first member cluster, in which a failure has occurred, from the resource-binding object and performing rescheduling when the failure-determination condition set in the resource-binding object is satisfied.

14. The method of claim 13, wherein the generating the PV-related resource delivery unit comprises,
detecting an updated resource-binding object and identifying a rescheduled second member cluster; and
generating a PV-related resource delivery unit in the namespace of the second member cluster.

15. The method of claim 14, wherein the generating the PV-related resource delivery unit comprises:
detecting the updated resource-binding object and generating a resource delivery unit in the namespace for the second member cluster.

16. The method of claim 15 further comprises,
releasing the suspension setting when PV status within the PV-related resource delivery unit in the namespace of the second member cluster is updated and the PV status transitions to an available state.

17. A computer program executed by a processor to automatically recover stateful workloads in Kubernetes-based multi-clusters, wherein the computer program is configured to perform operations comprising:
collecting specification information of a PersistentVolume (PV) associated with a StatefulSet resource deployed in a first member cluster;
storing the collected specification information in a PV-related resource delivery unit within a namespace of a first member cluster in the form of PV metadata;
when a failure occurs in the StatefulSet resource deployed in the first member cluster, identifying a rescheduled second member cluster, and generating a PV-related resource delivery unit in a namespace of the second member cluster by referring to the PV resource delivery unit; and
deploying PV resources associated with the StatefulSet resource in the second member cluster.
